(19) United States
(12) Patent Application Publication
(10) Pub. No.: US 2011/0086260 A1
(43) Pub. Date: Apr. 14, 2011

(54) THIN HOUSING FILM FOR ELECTROCHEMICAL ELEMENTS

(75) Inventors: Markus Kohlberger, Stuttgart (DE); Arno Perner, Munich (DE); Martin Krebs, Rosenberg (DE); Thomas Wöhrle, Stuttgart (DE); Robert Hahn, Berlin (DE); Krystan Marquardt, Berlin (DE); Elke Zangl, Ellwangen (DE)

(73) Assignee: VARTA MICROBATTERY GMBH, Hannover (DE)

(21) Appl. No.: 12/990,902

(22) PCT Filed: Apr. 30, 2009
(86) PCT No.: PCT/EP09/03132

§ 371 Date: Dec. 22, 2010

(30) Foreign Application Priority Data
May 3, 2008 (DE) 10 2008 023 571.7

(51) Int. Cl. H01M 2/02; B32B 7/02

(52) U.S. Cl. 429/163; 29/623.2; 428/336; 428/215; 428/195.1

(57) ABSTRACT

A housing film for electrochemical elements includes a barrier layer having a polymeric structure which has been deposited from the gas phase on to a support layer, an electrochemical element which has at least one positive electrode and at least one negative electrode and has at least one such film. A process for producing the electrochemical element includes steps wherein at least two electrodes are applied next to one another on a substrate and are covered with a film, where the substrate and/or the film is such a housing film.

### RELATED APPLICATIONS

This is a §371 of International Application No. PCT/EP2009/003132, with an international filing date of Apr. 30, 2009 (WO 2009/135621, published Nov. 12, 2009), which is based on German Patent Application No. 10 2008 023 571.7, filed May 3, 2008, the subject matter of which is incorporated herein by reference.

### TECHNICAL FIELD

This disclosure relates to a thin housing film for electrochemical elements, an electrochemical element having such a film and a process for producing such an electrochemical element.

### BACKGROUND

Owing to their high energy density combined with a low weight, in particular primary lithium cells and also secondary lithium ion cells, in particular lithium polymer cells, are used as preferred energy sources in many cases. In general, such cells always have a housing which can consist, for example, of a metal foil or of a multilayer composite film. Multilayer composite films used are, in particular, films having at least one layer of plastic and at least one metal layer. The metal layer functions, in particular, as actual protective layer against intrusion of moisture while the layer of plastic serves primarily as support and ensures mechanical stability of the composite and also provides protection against chemical attack.

Customary plastic films generally always have a certain permeability towards water vapor, which is why the metal layer is generally absolutely necessary. The metal foils used for such composite films generally have, as a result of the method of production, a thickness of at least 30 μm. The thickness of the metal foils is typically in the range from 40 to 50 μm. In combination with one or more layers of plastic and possibly further required layers of bonding agents, it is generally possible to obtain only housing foils which usually have a minimum thickness of about 85 μm. The thickness of aluminum composite films for pouch cells or soft packs is typically from 100 to 130 μm. A film having a sequence of the type
sealing film (e.g. polypropylene, 50 μm),
bonding agent (e.g. adhesive based on polyurethane, 5 μm),
metal foil (e.g. aluminum, 40 μm)
bonding agent (e.g. adhesive based on polyurethane, 5 μm)
outer film (e.g. polyamide, 25 μm)
   and having a total thickness of about 125 μm is a typical example of known housing films.

However, particularly in the case of very flat batteries having a cell height of only a few millimeters, in particular less than 1 mm, the energy density is decreased dramatically by use of such housing foils.

It could therefore be helpful to provide, in particular, improved films by which it is possible, in particular, to construct even very thin electrochemical elements which have a higher energy density than comparable known electrochemical elements.

### SUMMARY

We provide a housing film for electrochemical elements including a support layer that includes a plastic film, and a barrier layer deposited from a gas phase having a polymeric structure and a thickness in the range from 1 nm to 10,000 nm arranged on the support layer.

We also provide an electrochemical element including at least one positive electrode, at least one negative electrode and at least one housing film.

We further provide a process for producing the electrochemical element including applying at least two electrodes next to one another on the substrate and covering the electrodes with the housing film and the substrate and/or the film.

### BRIEF DESCRIPTION OF THE DRAWINGS

FIG. 1 is a graph showing a 40-hour discharge (I=0.1 mA, discharge capacity 4 mAh).

FIG. 2 is a graph showing internal resistance of the lithium cell as a function of time during storage under “tropical humidity” (45° C.). The solid line represents the curve for one of our lithium cells, while the broken line shows the curve for a comparative cell without a barrier layer. The increase in the internal resistance correlates with intrusion of moisture from the outside.

### DETAILED DESCRIPTION

Our films for electrochemical elements have a support layer and a barrier layer arranged thereon, wherein the barrier layer is a layer having a polymeric structure deposited from the gas phase.

Such a layer having a polymeric structure deposited from the gas phase has particular properties which make it particularly suitable as housing film or as constituent of a housing film for electrochemical elements. Surprisingly, films composed of the support and barrier layers described below have excellent mechanical properties and very good insulation properties despite their low thickness. In addition, the films have been found to be a very effective barrier against water and water vapor.

The barrier layer is a layer which, in particular, is intended to prevent permeation of water vapor through the film. A layer having a polymeric structure is any layer which is composed of high molecular weight chains and/or networks and is made up essentially of identical or related structural units.

Such structures are generally always produced using at least one suitable polymer precursor which can have, in particular, reactive individual monomers. Possible polymer precursors are essentially all compounds which are suitable for deposition from the gas phase. Particularly suitable materials will be discussed in more detail below.

The barrier layer is preferably a layer which has been applied by a CVD (chemical vapor deposition) process. Volatile compounds are deposited at a particular reaction temperature on a solid layer where they can react with one another to form the above-mentioned polymeric structure.

The barrier layer is particularly preferably a layer which has been applied by a PECVD (plasma enhanced chemical vapor deposition) process. The plasma enhanced chemical vapor deposition enables the temperature stress on the substrate to be coated to be reduced, which makes it possible to coat, inter alia, relatively sensitive substrates such as plastic films. For this process, a plasma in which a carrier gas containing the chemical compound to be deposited is excited is generated.

Very thin layers can be deposited by deposition processes such as the CVD process or the PECVD process. The procedures when carrying out CVD and PECVD processes are known and need not be explained in more detail.

In contrast to the above-mentioned known housing films/foils, our films preferably do not have a bonding layer between the barrier layer and further layers. However, it can be preferred that the support layer has been surface-treated before deposition of the barrier layer to ensure optimal adhesion. In particular, the support layer can be subjected to a corona treatment before deposition of the barrier layer. A corona treatment is, as is known, a widespread electrochemical process for surface modification in which a surface is exposed to a high-voltage electric discharge. Such a treatment generally increases the wettability of surfaces.

Further possible surface treatment processes are, in particular, flame treatment, chemical treatment such as fluorination and also plasma treatment.

The primary objective of all these methods is generally always increasing the polarity of the surface, which, as mentioned, significantly improves the wettability and the chemical affinity.

The barrier layer is particularly preferably a layer of an organic polymer. Possibilities are, in particular, polyparaxylylenes (parylenes). Parylene is, as is known, an inert, hydrophobic, optically transparent, polymeric material having a wide range of industrial uses. Parylene is generally produced by chemical vapor deposition. The starting material employed is, in particular, para-xylylene dimer or a halogenated derivative thereof. This can be vaporized and passed through a high-temperature zone. A highly reactive monomer is formed and generally reacts immediately on the surface of the substrate to be coated to give a chain-like polymer. To effect curing, it is merely necessary to keep the substrate to be coated at a temperature which is not too high, for example room temperature. Deposited parylene films are generally always pore-free and transparent. They are therefore eminently suitable as barrier layers.

Further preferably, the barrier layer is a layer of an inorganic-organic hybrid polymer, in particular an organosilicon layer. Such a layer can be deposited, for example, by the above-mentioned PECVD process.

Preference is given to the barrier layer having a thickness in the range from 1 nm to 10 000 nm. Desired thicknesses can be set relatively flexibly within this range by varying the deposition time and/or the other deposition conditions. Particular preference is given to thicknesses in the range from 25 nm to 5000 nm, in particular from 50 nm to 2500 nm.

The support layer is particularly preferably a film, in particular a plastic film, particularly preferably a film based on a polyolefin and/or a polyester (PETP film) and/or a polyimide (PI). Possible polyolefins are, in particular, polypropylene (PP), polyethylene (PE) and/or polyvinyl chloride (PVC). Composite films having a plurality of layers of different polymers can in principle also be used.

The support layer particularly preferably has a total thickness in the range from 0.5 μm to 50 μm, in particular from 1 μm to 25 μm, particularly preferably from 5 μm to 20 μm.

Further preferably, the film can comprise an electrically conductive layer or coating, in particular a metallic layer or coating, for example of copper or of a copper alloy. This firstly reinforces the film but, in particular, can also function as a power outlet lead and as a further barrier film against penetration of moisture.

The electrically conductive layer or coating preferably has a total thickness in the range from 1 nm to 5000 nm, in particular from 25 nm to 3000 nm, particularly preferably from 50 nm to 2000 nm.

In a further improvement, preferred films have one of the following sequences:
polymeric barrier layer
support layer
electrically conductive layer or coating
   or
electrically conductive layer or coating
polymeric barrier layer
support layer.

A film having such a sequence is particularly suitable as housing film for cells which are intended to be able to operate without separate power outlet leads, for instance because a particularly thin housing construction is necessary. The electrically conductive layer or coating is then preferably on the inside of the cell housing.

The electrically conductive layer or coating can, for example, be applied to the support layer by a PVD (physical vapor deposition) process. The term PVD process refers to a group of vacuum-based coating processes for thin film technologies in which, in contrast to the above-mentioned CVD processes, the layer or coating is formed directly by condensation of a vapor of the starting material. PVD processes are also known and do not have to be explained in more detail in this description. As an alternative, the electrically conductive layer or coating can, for example, also be applied by sputtering or vapor deposition.

Preferably, the electrically conductive layer or coating can also be a film, in particular a metal foil, which is, for example, adhesively bonded to the support film.

It can be preferred that the support layer, if appropriate with barrier layer applied thereto, is surface-treated before application of the electrically conductive layer or coating to ensure optimal adhesion, in a manner analogous to the possible surface treatment before application of the barrier layer. This is preferred particularly when the electrically conductive layer or coating is applied by a physical process.

Particularly preferably, the film has an electrically conductive layer or coating which is not continuous. Thus, the layer or coating can also be, in particular, made up of conductor tracks which are arranged on the support layer and/or on the barrier layer. For example, conductor tracks composed of copper can be adhesively bonded as foil on to the support layer or be applied with the aid of a mask by sputtering or a PVD process.

Particularly when an electrically conductive layer or coating is present as conductor track, it can also be preferred that it has been produced from an electrically conductive paste (e.g. a silver, graphite or copper paste). Such pastes can be applied to the support film, for example by a printing process. The pastes can advantageously contain binders in the form of polymers and/or polymer precursors which can be, for example, thermally or chemically solidified.

The films are thermally stable and resistant to customary electrolyte solutions under the normal operating conditions of a battery. Their action as permeation barrier may be particularly emphasized. Tests on the permeability of the films have indicated that in respect of the permeation of water vapor, values which are at least as good as those obtained using classical composite films, as mentioned at the outset, were achieved.

An electrochemical element has at least one positive electrode and at least one negative electrode. It additionally has at least one film which has the above-described properties and can serve, in particular, as housing film to protect the electrodes.

The electrochemical element particularly preferably has a housing which essentially completely surrounds or envelopes the electrodes and consists at least partly of the at least one film. Thus, the housing can, for example, consist of two films which are adhesively bonded to one another (for example, by a sealing film) or welded and form a type of pocket in which the electrodes are located. In this instance, the electrodes can be provided with power outlet leads which are conducted out of the housing and on the outside form the poles of the electrochemical element.

As an alternative, it is naturally also possible to use at least one film having an electrically conductive layer as described above, in which case the electrically conductive layer can then perform the function of the power outlet lead or leads. If appropriate, the films are insulated from one another by, for example, a sealing film. In particular, it is naturally also possible to use films which have the above-mentioned conductor tracks arranged on the support layer and/or on the barrier layer. More will be said about this later.

Owing to their low thickness, films are particularly suitable for producing very thin electrochemical elements, in particular flat cells having a cell height of <3 mm, particularly preferably <2 mm, in particular <1 mm.

Such cells can be, for example, primary lithium ion cells or secondary lithium ion cells. The electrochemical element particularly preferably has at least one lithium-intercalating electrode. Accordingly, the electrochemical element is preferably a lithium ion cell. Suitable active materials such as lithium cobalt oxide for the positive electrode or graphite/carbon for the negative electrode are known and need not be explained in more detail. The same applies to suitable electrolytes and separators which can be matched to the respective active materials. In primary lithium cells, manganese dioxide (MnO₂) is preferably used as active material for the cathode, while the anode consists of metallic lithium foil.

The electrochemical element can particularly preferably also be a battery which has been produced at least in parts by one or more printing operations. Apart from the electrically conductive layer or coating (see above), the electrodes, for example, can also be produced by printing operations. Thus, the electrochemical element can be, for instance, a zinc-manganese dioxide element in which the electrodes have been produced from a zinc paste composed of zinc powder, a suitable binder and a solvent (as anode material) and a manganese dioxide paste composed of manganese dioxide, a suitable binder and a solvent, optionally with graphite and/or carbon as conductive material (as cathode material).

Particularly preferably, an electrochemical element has at least one positive electrode and at least one negative electrode which are arranged next to one another on a substrate.

Further particularly preferably, an electrochemical element has at least two positive electrodes and/or at least two negative electrodes which are arranged next to one another on a substrate.

Such electrodes can be connected in parallel or in series. Voltage, capacity and pulse chargeability can be flexibly adapted in this way. For example, connection of ten units having a voltage of 3.1 V (electrochemical system: lithium-MnO₂) in series makes it possible to obtain an electrochemical element having a voltage of about 31 V.

The substrate is in both cases preferably a sheet-like substrate such as paper or a film, with the use of a plastic film or plastic composite film as substrate being more preferred. The substrate is preferably either electrically nonconductive (a possibility here is, in particular, a film without an electrically conductive layer or coating) or partly conductive. In the second case, possibilities are, in particular, films having conductor tracks arranged thereon, as have been described above.

In a structure with the at least one positive electrode and at least one negative electrode arranged next to one another on a substrate, the electrodes are preferably connected to one another via an electrolyte, in particular an ion-conductive electrolyte, which preferably at least partly covers the electrodes. Possible ion-conductive electrolytes are, in particular, gel-like electrolytes, for example electrolytes based on polyethylene oxide (PEO), or electrolytes based on an ion-conducting ceramic.

Like the electrically conductive layer or coating, such electrodes can also be produced or applied by a printing operation. Thus, for example, at least one positive electrode and at least one negative electrode can be applied next to one another on the substrate in a first printing operation and the electrolyte can be applied (e.g. as thin layer covering the electrodes) in a second printing operation.

As mentioned above, the electrodes are particularly preferably applied to a film which has the above-mentioned conductor tracks on its surface as substrate. Thus, a structure of conductor tracks having predefined places for the electrodes can be applied to one of the above-described films having a support layer and a barrier layer and the electrodes can then be printed on, for example, in the next step. Separate power outlet leads are then no longer necessary.

As a result of the arrangement of the electrodes next to one another, the functional parts of the electrochemical element are arranged in only very few levels above one another. Preferably, an electrochemical element has the following sequence of levels:
film with conductor tracks arranged thereon as substrate and
at least two electrodes arranged next to one another on the substrate (where the electrodes are in direct contact with the conductor tracks).

The two electrodes arranged next to one another on the substrate can be, for example, the at least one positive electrode and the at least one negative electrode. In particular, there is, in this case, generally another third level of electrolyte which connects the electrode and at least partly covers the latter. Furthermore, the at least two positive electrodes and/or at least two negative electrodes are also possible as electrodes.

Particularly in combination with a further film (preferably without electrically conductive layer or coating) which together with the substrate forms a housing which encloses the electrodes and the electrolyte and seals them in, an overall particularly flat and thin construction of an electrochemical element having an extraordinarily high energy density can be achieved. The electrochemical element is accordingly also particularly suitable for the field of polymer electronics or smart labels and also for electronic medical sticking plasters.

We further provide a process for producing an electrochemical element. In the process, at least two electrodes are applied next to one another on a substrate and covered with a film. The substrate and/or the film is one of the above-described films having a barrier layer arranged on a support layer.

Preferably, the at least two electrodes are the above-mentioned at least one positive electrode and at least one negative electrode.

Further preferably, the at least two electrodes can be the above-mentioned at least two positive electrodes and/or at least two negative electrodes.

The substrate and/or the film is preferably a film with conductor tracks applied thereto.

The covering film can, for example, be adhesively bonded on to the substrate or be welded to the substrate in such a way that it completely covers the electrodes and the electrolyte and together with the substrate forms the sealing housing mentioned above.

As regards the properties of the electrodes, the substrate, the electrolytes and the covering film, what has been said above is incorporated by reference.

Particularly preferably, in the process, the electrodes and/or the electrolyte can be printed on to the substrate, as described, for example, in WO 2006/105966, the subject matter of which is incorporated by reference.

Further features can be derived from the following description of preferred examples. The individual features can each be realized by themselves or as a combination of a plurality thereof in a selected structure. The particular examples described are merely for the purpose of illustration and to give a better understanding and are not to be construed as constituting a restriction.

### EXAMPLES

A film A was produced in the following way:

A 25 μm thick PETP film was stretched on a suitable device and freed of any adhering dust particles by deionized water and blowing nitrogen on to it. The film was then installed in a plasma reactor and treated with a plasma at a power of 240 W and a chamber pressure of 7.5 mbar to activate the surface. Optimal results are achieved using a two-stage plasma of oxygen/sulfur hexafluoride and pure oxygen as reaction gases. The gas flow was about 54/6 sccm for the gas mixture in the O₂/SF₆ step and 60 sccm for the oxygen step.

Parylene C was subsequently deposited as barrier layer at a pressure of about 0.03 mbar. For this purpose, a suitable reactor comprising a vaporizer, a pyrolysis furnace and an evacuatable reactor space was used. The parylene was deposited from the gas phase in the reactor space. The layer thickness produced was about 2 μm.

A second film B having a power outlet function was produced in the following way:

A film A produced in the described manner was provided with power outlet leads by activating the parylene layer with an oxygen plasma (60 sccm) at a power of 200 W and a chamber pressure of 7.5 mbar and subsequently applying a Ti/W/Au layer by sputtering. The sputtering parameters were selected so that the power outlet structures produced introduced very little mechanical stress into the total structure.

Films produced in this way were subsequently assembled to produce an electrochemical element as follows:

A paste-like cathode composition was produced by intimately mixing 88 percent by weight of manganese dioxide activated thermally at 360° C. (electrolytic MnO₂), 4 percent by weight of conductive carbon black (Super P, from Timcal Belgium) and 8 percent by weight of polyvinylidene fluoride hexafluoropropylene PVdF-HFP (Solef 21216, from Solvay) in acetone and applying the composition obtained in this way to the electrically conductive layer (the power outlet lead) of a film B which had been produced as described above. The carrier solvent was subsequently evaporated and the resulting electrode tape was vacuum dried (110° C., 48 h). The dried tape was impregnated with a liquid lithium electrolyte and a polyolefin separator was placed on top. The stack of electrode and separator was then laid in a half housing of film B on to whose inside a 70 μm thick lithium foil had been pressed beforehand so as to establish electric contact with the power outlet lead. The two film half housings were welded together by ultrasound. The resulting primary lithium cell had an open-circuit voltage of about 3.1 V.

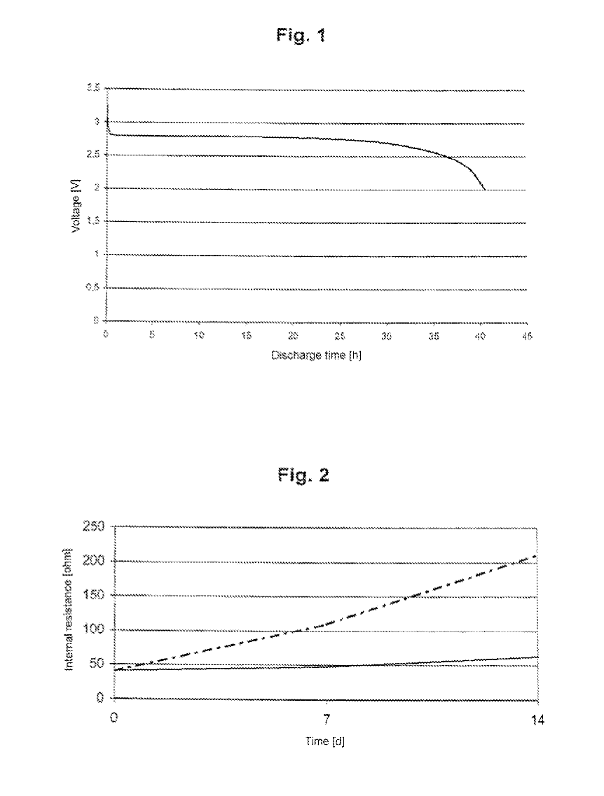

The results of functional tests using the cell produced in this way are shown in FIGS. 1 and 2.

1.-17. (canceled)

18. A housing film for electrochemical elements comprising:
a support layer comprising a plastic film, and
a barrier layer deposited from a gas phase having a polymeric structure and a thickness in the range from 1 nm to 10,000 nm arranged on the support layer.

19. The film as claimed in claim 18, wherein the barrier layer is applied by a CVD process.

20. The film as claimed claim 18, wherein the barrier layer comprises an organic polymer.

21. The film as claimed in claim 18, wherein the barrier layer comprises a parylene layer.

22. The film as claimed in claim 18, wherein the barrier layer comprises an inorganic-organic hybrid polymer.

23. The film as claimed in claim 18, wherein the barrier layer comprises an organosilicon layer.

24. The film as claimed in claim 18, wherein the barrier layer has a thickness of 25 nm to 5000 nm.

25. The film as claimed claim 18, wherein the support layer is based on a polyolefin and/or a polyester and/or polyimide.

26. The film as claimed in claim 18, wherein the support layer has a total thickness of 0.5 μm to 50 μm.

27. The film as claimed claim 18, further comprising an electrically conductive layer or coating.

28. The film as claimed in claim 27, wherein the electrically conductive layer or coating comprises conductor tracks arranged on the support layer and/or on the barrier layer.

29. An electrochemical element comprising at least one positive electrode; at least one negative electrode; and at least one film as claimed in claim 18.

30. The electrochemical element as claimed in claim 29, further comprising a housing surrounding the electrodes.

31. The electrochemical element as claimed in claim 29, having a cell height of <3 mm.

32. The electrochemical element as claimed in claim 29, wherein the at least one positive electrode and the at least one negative electrode are arranged next to one another on a sheet-like substrate.

33. The electrochemical element as claimed in claim 29, comprising at least two positive electrodes and/or at least two negative electrodes arranged next to one another on a sheet-like substrate.

34. The electrochemical element as claimed in claim 29, further comprising:
a sequence of conductor tracks in an electrically conductive layer or coating arranged on the support layer and/or the barrier layer; and
at least two electrodes arranged next to one another on the film and in electrical contact with at least one of the conductor tracks.

35. A process for producing the electrochemical element as claimed in claim 29, comprising:
applying the at least two electrodes next to one another on the substrate; and
covering the electrodes with the film and the substrate and/or the film.

36. The process as claimed in claim 35, wherein the electrodes are printed on to the substrate.
